(19) United States
(12) Patent Application Publication
(10) Pub. No.: US 2025/0180437 A1
(43) Pub. Date: Jun. 5, 2025

(54) RETREADING POSSIBILITY DETERMINATION METHOD AND RETREADING POSSIBILITY DEVICE

(71) Applicant: BRIDGESTONE CORPORATION, Tokyo (JP)

(72) Inventors: Eiji MIYAKE, Chuo-ku, Tokyo (JP); Junko ISHIDA, Chuo-ku, Tokyo (JP); Takanao SHOJI, Chuo-ku, Tokyo (JP); Yuki HARA, Chuo-ku, Tokyo (JP); Kenji TOYODA, Chuo-ku, Tokyo (JP)

(73) Assignee: BRIDGESTONE CORPORATION, Tokyo (JP)

(21) Appl. No.: 18/843,399

(22) PCT Filed: Jan. 10, 2023
(86) PCT No.: PCT/JP2023/000331

§ 371 Date: Sep. 3, 2024

(30) Foreign Application Priority Data
Mar. 9, 2022 (JP) 2022-036557

(51) Int. Cl. G01M 17/02

(52) U.S. Cl. CPC G01M 17/02

(57) ABSTRACT

A retreadability determination method includes a step (S1) of acquiring a state characteristic value, indicating a state of the tire, to be used in a first determination and a second determination, a step (S2) of executing the first determination, and a step (S9) of executing the second determination in a case in which it is determined in the first determination that the tire can be retreaded. The first determination is one of a chemical degradation state determination using a residual durability of the base tire calculated based on a chemical change in rubber material of the tire and a physical degradation state determination using a residual durability of the base tire calculated based on a state of physical damage to the tire, and the second determination is the other of the chemical degradation state determination and the physical degradation state determination.

### TECHNICAL FIELD

The present disclosure relates to a retreadability determination method and a retreadability determination apparatus.

### BACKGROUND

In recent years, for reasons such as the increasing use of retreaded tires, technology for understanding the degradation state of tires has been attracting attention. To prevent the cost of retreading from being wasted when retreading a tire, the base tire must retain sufficient durability to withstand use after retreading. For example, Patent Literature (PTL) 1 discloses a method for evaluating the durability of a base tire before retreading based on the rubber degradation state, which in turn is based on thermal history information during tire use.

### CITATION LIST

### Patent Literature

PTL 1: JP 2014-046879 A

### SUMMARY

### Technical Problem

Here, not only the chemical state such as the rubber degradation state, but also, for example, internal physical damage to the base tire may affect the residual durability of the base tire. Therefore, demand exists for technology that can further improve the accuracy of the evaluation of the residual durability of the base tire and more accurately determine whether the base tire can withstand use after retreading.

In light of such circumstances, it is an aim of the present disclosure to provide a retreadability determination method and a retreadability determination apparatus that can accurately determine whether a tire can be retreaded.

### Solution to Problem

A retreadability determination method according to an embodiment of the present disclosure is a retreadability determination method for determining whether a tire can be retreaded, the tire including a tread and a base tire disposed on a tire radial inner side of the tread, the retreadability determination method including acquiring a state characteristic value, indicating a state of the tire, to be used in a first determination and a second determination; executing the first determination; and executing the second determination in a case in which it is determined in the first determination that the tire can be retreaded, wherein the first determination is one of a chemical degradation state determination using a residual durability of the base tire calculated based on a chemical change in rubber material of the tire and a physical degradation state determination using a residual durability of the base tire calculated based on a state of physical damage to the tire, and the second determination is the other of the chemical degradation state determination and the physical degradation state determination.

A retreadability determination apparatus according to an embodiment of the present disclosure is a retreadability determination apparatus for determining whether a tire can be retreaded, the tire including a tread and a base tire disposed on a tire radial inner side of the tread, the retreadability determination apparatus including an acquisition interface configured to acquire a state characteristic value, indicating a state of the tire, to be used in a first determination and a second determination; and a determiner configured to execute the first determination and execute the second determination in a case in which it is determined in the first determination that the tire can be retreaded, wherein the first determination is one of a chemical degradation state determination using a residual durability of the base tire calculated based on a chemical change in rubber material of the tire and a physical degradation state determination using a residual durability of the base tire calculated based on a state of physical damage to the tire, and the second determination is the other of the chemical degradation state determination and the physical degradation state determination.

### Advantageous Effect

According to the present disclosure, a retreadability determination method and a retreadability determination apparatus that can accurately determine whether a tire can be retreaded can be provided.

### BRIEF DESCRIPTION OF THE DRAWINGS

In the accompanying drawings:

FIG. 1 is a diagram illustrating a configuration example of a retreadability determination apparatus according to an embodiment of the present disclosure;

FIG. 2 is a diagram illustrating a configuration example of a retreadability determination system that includes the retreadability determination apparatus in FIG. 1;

FIG. 3 is a diagram illustrating the change in total thermal history of a tire; and

FIG. 4 is a flowchart for a retreadability determination method according to an embodiment of the present disclosure.

### DETAILED DESCRIPTION

A retreadability determination apparatus and a retreadability determination method according to embodiments of the present disclosure are described below with reference to the drawings. Parts in the drawings that are the same or correspond are allotted the same reference signs. In the explanation of the present embodiment, a description of identical or equivalent portions is omitted or simplified as appropriate.

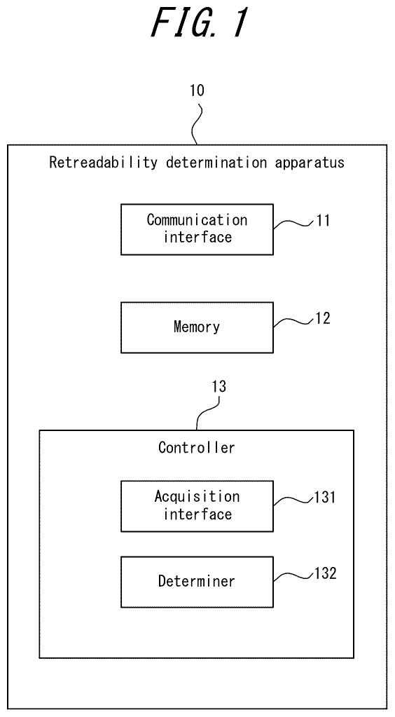

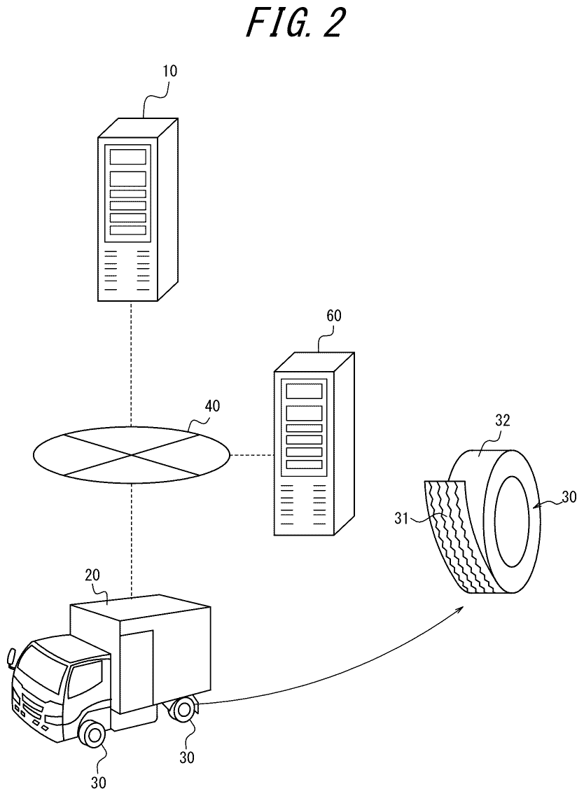

FIG. 1 is a diagram illustrating the functional blocks of a retreadability determination apparatus 10 according to an embodiment of the present disclosure. FIG. 2 illustrates a configuration example of a retreadability determination system that includes the retreadability determination apparatus 10 in FIG. 1.

The retreadability determination apparatus 10 determines whether a tire 30, having a tread 31 and a base tire 32, can be retreaded. While examples of the constituent members of the tire 30 include the tread 31, a bead, a carcass, a belt, and the like, the base tire 32 refers to the portion of the tire 30 other than the tread 31 and is located on the tire radial inner side of the tread 31, as illustrated in FIG. 2. Retreading refers to the process of scraping off the tread 31 of the tire 30, affixing and vulcanizing new rubber, and then reusing the tire 30. When the tire 30 is retreaded, the base tire 32 must remain durable enough to withstand use after retreading. The retreadability determination apparatus 10 can accurately determine whether the tire 30 can be retreaded, as described below. Here, the type of the tire 30 is not particularly limited. The tire 30 may, for example, be a tire mounted on a standard-sized automobile, a tire mounted on a truck, or an OR (off the road) tire mounted on a large construction vehicle or the like.

As illustrated in FIG. 1, the retreadability determination apparatus 10 includes a communication interface 11, a memory 12, and a controller 13. The controller 13 includes an acquisition interface 131 and a determiner 132. In terms of hardware configuration, the retreadability determination apparatus 10 may, for example, be a computer connected to a network 40. Details of the constituent elements of the retreadability determination apparatus 10 are described below.

### (Retreadability Determination System)

The retreadability determination apparatus 10, together with a server 60 connected over the network 40, may form a retreadability determination system. The network 40 is, for example, the Internet, but may be a Local Area Network (LAN). The server 60 is, for example, a different computer than the retreadability determination apparatus 10. The server 60 is not limited to a certain location but may, for example, be located at a management facility. The management facility is a facility for managing tires 30 mounted on a vehicle 20 and performs inspections, repairs, retreading, and the like of the tires 30. The server 60 may receive a determination of the retreadability of the tire 30 from the retreadability determination apparatus 10 and share the determination result with a user by displaying the determination on a display or the like connected to the server 60. Here, the user is the user of the management facility where retreading and the like are performed. In particular, the user is the manager, owner, or driver of the vehicle 20. The server 60 may also maintain data such as a history of retreading and repair of the tires 30.

In the present embodiment, the management facility where the server 60 is installed inspects the state of physical damage to the tire 30, which is used in the physical degradation state determination described below. The server 60 outputs the state of physical damage to the tire 30 obtained by the inspection to the retreadability determination apparatus 10 as a state characteristic value indicating the state of the tire 30. The physical inspection is described here as being performed at the management facility in the present embodiment, but the location of the physical inspection is not limited. The physical inspection may be performed on the user's premises, at the location where the vehicle 20 is used, or the like. In a case in which retreading is performed on the tire 30 at the management facility, the server 60 outputs information on the temperature (heat) applied to the tire 30 by the process of vulcanization to the retreadability determination apparatus 10 as a state characteristic value. Here, the management facility may be in the same area as the recycling facility that recycles tires 30 that are considered not to be retreadable.

The vehicle 20 includes a communication apparatus that can be connected to the network 40 and a measurement apparatus that measures the state characteristic values of the tire 30. In the present embodiment, the state characteristic values measured by the measurement apparatus include the temperature of the tire 30. The measurement apparatus is configured to include a temperature sensor, for example. The state characteristic values including the temperature of the tire 30 are outputted to the retreadability determination apparatus 10 via the communication apparatus and the network 40. Here, “to measure” means being able to obtain the state characteristic values of the tire 30, whether directly or indirectly, and also includes the case in which the state characteristic values are obtained by performing some calculation on directly measured parameters or the like.

In the present embodiment, the state characteristic values measured by the measurement apparatus include driving parameters of the tire 30. The driving parameters may, for example, include the driving distance, driving time, and the like. The state characteristic values including the driving parameters of the tire 30 are outputted to the retreadability determination apparatus 10 via the communication apparatus and the network 40.

The temperature of the tire 30 included in the state characteristic values may be outputted to the retreadability determination apparatus 10 as the temperature of the constituent members of the tire 30. For example, the measurement apparatus may be mounted in the chamber, and the measurement apparatus may convert the temperature measured in the chamber to the temperature of the constituent members. The chamber is the space between the inner surface of the tire 30 and the rim wheel.

For example, if the temperature measured in the chamber is Tch, and α, β, γ, and δ are coefficients, the temperature T of a certain constituent member (tread 31, belt, bead, or the like) can be calculated using Equation (1) below as an example.

$$T = α \times {( Tch \times β + γ )}^{\frac{1}{2}} + δ \qquad Equation ( 1 )$$

Here, the coefficients α, β, γ, and δ are obtained in advance. The coefficients α, β, γ, and δ that minimize error can be obtained by fitting based on past data or the like, for example. The coefficients α, β, γ, and δ are obtained for each constituent member and may differ by constituent member.

### (Retreadability Determination Apparatus)

As described above, the retreadability determination apparatus 10 includes the communication interface 11, the memory 12, and the controller 13 that includes the acquisition interface 131 and the determiner 132. The communication interface 11 is configured to include one or more communication modules that connect to the network 40. The communication interface 11 may include a communication module corresponding to mobile communication standards, such as 4G (4^{th} Generation) and 5G (5^{th} Generation). The communication interface 11 may include a communication module corresponding to wired LAN standards (for example, 1000BASE-T). The communication interface 11 may include a communication module corresponding to wireless LAN standards (for example, IEEE802.11).

The memory 12 includes one or more memories. The memory can, for example, be a semiconductor memory, a magnetic memory, or an optical memory, but is not limited to these examples and can be any memory. The memory 12 is, for example, built into the retreadability determination apparatus 10, but the memory 12 can also be configured to be accessed externally by the retreadability determination apparatus 10 via any interface.

The memory 12 stores various data used in the various calculations performed by the controller 13. The memory 12 may also store the results and intermediate data of the various calculations performed by the controller 13. The memory 12 may also store programs.

In the present embodiment, the memory 12 stores parameters and the like for calculating the residual durability of the base tire 32 in the chemical degradation state determination and physical degradation state determination described below. Here, in the present embodiment, the predicted driving range is used as the residual durability, but this example is not limiting. The driveable time or the like may be used as the residual durability. In the present embodiment, the memory 12 stores the total thermal history for each tire 30 or vehicle 20. The total thermal history corresponds to the sum of the heat applied to the tire 30. In the present embodiment, the memory 12 also stores a durability limit or the like, which is determined according to factors such as the type of the tire 30 and indicates the lifespan of the tire 30. In the present embodiment, the memory also 12 stores the cost of a new tire 30, the cost of retreading the tire 30, and the like.

The controller 13 is configured to include one or more processors. The processors can, for example, be a general purpose processor or dedicated processor specialized for specific processing, but these examples are not limiting, and any processor may be used. The controller 13 controls the overall operations of the retreadability determination apparatus 10.

Here, the retreadability determination apparatus 10 may have the following software configuration. One or more programs used to control the operations of the retreadability determination apparatus 10 are stored in the memory 12. When read by the processor of the controller 13, the programs stored in the memory 12 cause the controller 13 to function as the acquisition interface 131 and the determiner 132.

The acquisition interface 131 acquires the state characteristic values indicating the state of the tire 30 via the network 40 and the communication interface 11. The state characteristic values are used in the first determination and the second determination described below. The state characteristic values may be further used in the third determination described below.

The determiner 132 makes a multifaceted determination of whether the tire 30 can be retreaded by combining a plurality of different determination methods over multiple steps. The determiner 132 may output the determination result to, for example, the server 60, the user's terminal apparatus (such as a smartphone), or the like. The determiner 132 may output the determination result from each of the plurality of determination methods or may output only the final determination result. The determiner 132 uses at least two determination methods. The determiner 132 executes a first determination (primary determination) and executes a second determination (secondary determination) when it is determined in the first determination that the tire 30 can be retreaded.

Here, a chemical degradation state determination and a physical degradation state determination can be used as methods for determining the degradation state of the tire 30. The chemical degradation state determination is a method for determining retreadability using the residual durability of the base tire 32 calculated based on chemical changes in the rubber material of the tire 30. The physical degradation state determination is a method for determining retreadability using the residual durability of the base tire 32 calculated based on the state of physical damage to the tire 30. The first determination is one of the chemical degradation state determination and the physical degradation state determination. The second determination is the other of the chemical degradation state determination and the physical degradation state determination. In the present embodiment, the determiner 132 executes the chemical degradation state determination as the first determination and the physical degradation state determination as the second determination. Since the determination is made by considering not only the chemical state of the tire 30 but also the physical damage and the like to the base tire 32, which can affect the residual durability, the precision in evaluating the residual durability of the base tire 32 can be further improved, and a determination of whether the base tire 32 can withstand use after retreading can be made more accurately. In other words, the retreadability determination apparatus 10 can accurately determine whether the tire 30 can be retreaded.

The determiner 132 executes the chemical degradation state determination as follows, for example. The determiner 132 calculates the total thermal history by integrating the temperature applied to the tire 30 over the driving time based on the state characteristic values acquired by the acquisition interface 131. The determiner 132 can determine whether the tire 30 can be retreaded by reading the value of the durability limit for the total thermal history from the memory 12 and determining the driving distance until the durability limit. Here, the durability limit indicates the lifespan of the tire 30 based on the total thermal history. The driving distance until the durability limit is the predicted driving range and corresponds to the residual durability of the base tire 32.

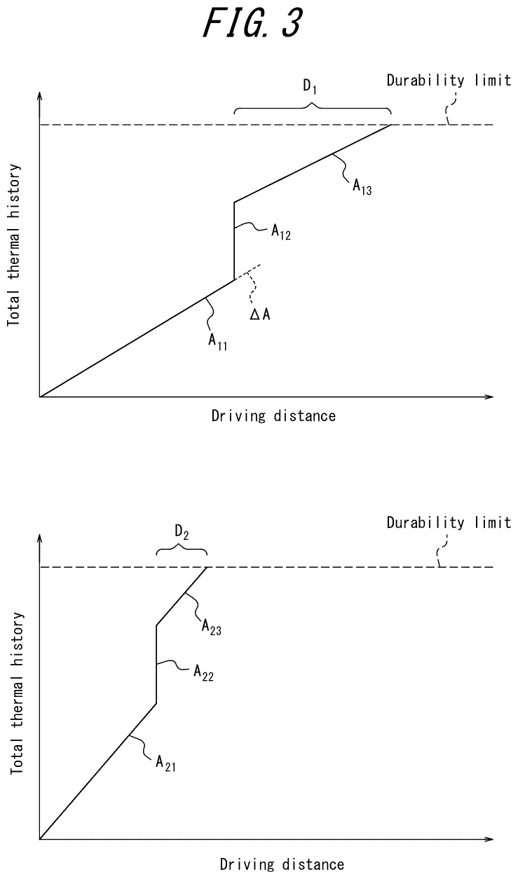

FIG. 3 is a diagram illustrating the change in total thermal history of the tire 30. First, the upper diagram in FIG. 3 is described. The total thermal history of the tire 30 is indicated as a solid line with sections A₁₁, A₁₂, and A₁₃. ΔA is discussed below. The vertical axis represents the magnitude of the total thermal history. The horizontal axis represents the driving distance. As the driving distance of the vehicle 20 increases, heat is added to the tire 30, and the total thermal history increases. When the durability limit is reached, the lifespan of the tire 30 is reached. Section A₁₁ of the total thermal history illustrates the change before the determination of whether retreading is possible and indicates how heat is added to the tire 30 by driving of the vehicle 20. Section A₁₂ of the total thermal history illustrates the effect of retreading vulcanization (heat added during vulcanization) in the case of retreading the tire 30. Section A₁₃ of the total thermal history corresponds to driving after retreading in the case of retreading the tire 30. In other words, section A₁₃ indicates the predicted change in the total thermal history after retreading. The determiner 132 may, for example, determine the slope of the section A₁₃ based on the slope of the section A₁₁. The determiner 132 can determine whether the tire 30 can be retreaded based on the length of D₁, which is the driving distance until the durability limit after retreading. The determiner 132 can, for example, establish a reference value and determine that retreading is possible if the length of D₁ is equal to or greater than the reference value.

Here, the lower diagram in FIG. 3 illustrates the change in the total thermal history of a tire 30 mounted on a vehicle 20 that drives in a high temperature environment. The total thermal history of the tire 30 has sections A₂₁, A₂₂, and A₂₃, corresponding respectively to A₁₁, A₁₂, and A₁₃ in the upper diagram. The slopes of the sections A₂₁ and A₂₃ of the total thermal history are larger than those of the sections A₁₁ and A₁₃ in the upper diagram. As a result, the length of D₂, which is the driving distance until the durability limit after retreading, is shorter than D₁ in the upper diagram. The determiner 132 may, for example, determine that retreading is not possible based on a comparison with a reference value.

In the present embodiment, the determiner 132 takes into account the effect of retreading on the residual durability of the base tire 32, as in section A₁₂ and section A₂₂, in the chemical degradation state determination. The retreadability determination apparatus 10 can therefore more accurately determine whether the tire 30 can be retreaded. Here, the tire 30 may be retreaded multiple times. For tires 30 that have been retreaded in the past, the effect of vulcanization on the total thermal history for past retreads is also added.

The determiner 132 performs the physical degradation state determination as follows, for example. The determiner 132 may determine whether there are cracks or the like in the tire 30 based on the state characteristic values acquired by the acquisition interface 131 and determine that retreading is not possible in the case of large cracks or the like. The determiner 132 may calculate the residual durability of the base tire 32 according to the location or the like in the case of a crack or the like that is less than a predetermined size. The determiner 132 may calculate the residual durability based on the failure risk by location, such as the belt, carcass, bead, and the like. Such failure risks can be prepared in advance based on data on past failures and the like.

In the physical degradation state determination, the determiner 132 uses the state of physical damage to the tire 30, among the state characteristic values, to make the determination. The state of physical damage to the tire 30 may be obtained by at least one of visual inspection of the exterior of the tire 30, inspection using an image of the exterior, and inspection of the interior of the tire 30 using a shearograph, x-ray, or echo. Here, the echo is not limited to ultrasonic reflection. For example, the echo may include the reflection of sound when the tire is impacted. Such an inspection can be used to obtain information on the state of physical damage to the tire 30 in a non-destructive manner. Among the aforementioned inspections, a visual inspection of the exterior of the tire 30 may always be performed. The inspection of the exterior and the interior of the tire 30 may be performed at the management facility where the server 60 is installed, as described above.

The determiner 132 may execute the third determination (additional determination) when it is determined in the first determination (primary determination) or the second determination (secondary determination) that the tire 30 is retreadable. In the third determination, a determination of whether the tire 30 can be retreaded is made from a cost-benefit perspective. The third determination can be referred to as an “additional determination from a cost-benefit perspective” that can be performed after each of the first determination and the second determination. The third determination is not limited to being performed once and may be performed multiple times. For example, in a case in which retreading is determined to be possible in the first determination, a first-round third determination may then be performed to determine whether retreading, including cost effectiveness, is possible. The second determination may be performed in a case in which retreading is determined to be possible as the overall result of the first determination and the first-round third determination. In a case in which retreading is determined to be possible in the second determination as well, a second-round third determination may then be performed to make a final determination of whether retreading, including cost effectiveness, is possible. In this example, in a case in which retreading is determined not to be possible in the second determination, or the second determination is not performed, the second-round third determination is not performed. Furthermore, in a case in which retreading is determined not to be possible in the first determination, the third determination is not performed.

The third determination determines whether retreading is possible by comparing the residual durability of the base tire 32 in the first determination or second determination with a threshold determined based on the cost of replacement with a new tire 30. In the present embodiment, the residual durability of the base tire 32 is the driving distance until the durability limit (hereinafter referred to as Da) obtained by the chemical degradation state determination or physical degradation state determination. For example, the determiner 132 reads, from the memory 12, the cost in the case of replacement with a new tire 30 and the driving distance until the lifespan as per the specifications of the new tire 30 (hereinafter referred to as Db). The determiner 132 may compare the value (an example of a threshold) yielded by multiplying the cost of the new tire 30 by “Da/Db” with the cost of retreading and determine that retreading is possible in a case in which the cost of retreading is cheaper. By execution of the third determination, it is possible to determine whether retreading of the tire 30 is possible while taking into account the cost effectiveness for the user.

### <Retreadability Determination Method>

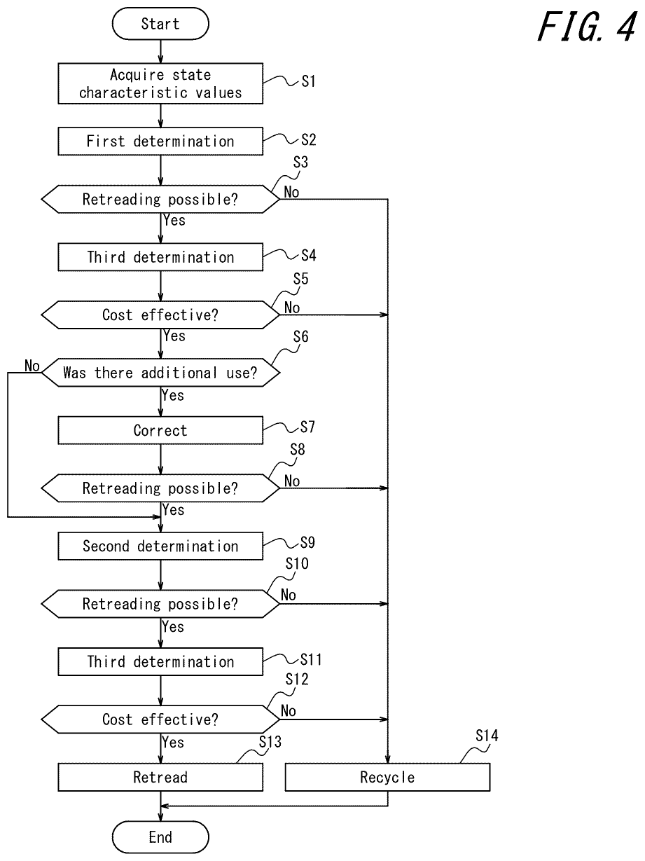

The retreadability determination method according to the present embodiment is preferably executed by the aforementioned retreadability determination apparatus 10. FIG. 4 is a flowchart illustrating the process of the retreadability determination method according to the present embodiment.

The acquisition interface 131 acquires the state characteristic values indicating the state of the tire 30 via the network 40 and the communication interface 11 (step S1).

The determiner 132 executes the first determination (step S2). In the present embodiment, the first determination is the chemical degradation state determination. As described above, the determiner 132 calculates the total thermal history and predicts the driving range as the residual durability of the base tire 32. The determiner 132 determines whether the tire 30 can be retreaded based on the predicted driving range.

In a case in which the determiner 132 determines in the first determination that retreading of the tire 30 is possible (Yes in step S3), the process proceeds to step S4. In a case in which the determiner 132 determines in the first determination that retreading of the tire 30 is not possible (impossible) (No in step S3), the determiner 132 outputs, as the final determination result, an indication that the tire 30 should be recycled (step S14). A message indicating the final determination result of recycling (i.e., not retreadable) is displayed on a display connected to the server 60, for example, and the user may arrange for the tire 30 to be sent to a recycling process in the same facility or transported to another recycling facility. Here, in step S14, disposal of the tire 30 may be presented as an option. In other words, an indication that the tire 30 should be recycled or disposed of may be outputted as the final determination result.

In a case in which the determiner 132 determines that retreading of the tire 30 is possible, the determiner 132 subsequently performs a first-round third determination (additional determination) to determine the cost effectiveness (step S4). In a case in which the determiner 132 determines in the third determination that retreading of the tire 30 is cost effective (Yes in step S5), the process proceeds to step S6. In a case in which the determiner 132 determines in the third determination that retreading is not cost effective (No in step S5), the determiner 132 outputs, as the final determination result, an indication that the tire 30 should be recycled (step S14).

Here, in the present embodiment, the first determination is the chemical degradation state determination. Therefore, even if something that could affect the residual durability of the base tire 32 occurs before the execution of the second determination, which is the physical degradation state determination, a prediction that includes the effect can be made. Specifically, additional use, such that the tire 30 is used for driving while still attached to the vehicle 20, is possible after the first determination is executed until the second determination is executed. This configuration is highly convenient for the user, since the user can continue to use the vehicle 20 until execution of the second determination. The residual durability of the base tire 32 in the first determination is corrected based on the driving conditions of the vehicle 20 in the additional use (such as the additional driving distance). It is therefore possible to determine accurately whether the tire 30 can be retreaded even in the case of additional use. In the present embodiment, the second determination need not be executed immediately after the first determination and may be executed after the time of additional use from the first determination.

In a case in which there is additional use of the tire 30 after the first determination (Yes in step S6), the determiner 132 corrects the residual durability of the base tire 32 in the first determination (step S7). The correction is to recalculate the length of D₁, which is the driving distance until the durability limit, after adding the driving distance due to additional use, for example ΔA in the upper diagram in FIG. 3, and redetermine whether retreading is possible.

In a case in which the determiner 132 determines, in the redetermination of the first determination, that retreading of the tire 30 is not possible (No in step S8), the determiner 132 outputs, as the final determination result, an indication that the tire 30 should be recycled (step S14).

In a case in which the determiner 132 determines, in the redetermination of the first determination, that retreading of the tire 30 is possible (Yes in step S8), or in a case in which there is no additional use of the tire 30 (No in step S6), the process proceeds to step S9.

The determiner 132 executes the second determination (step S9). In the present embodiment, the second determination is the physical degradation state determination. As described above, the determiner 132 predicts the residual durability of the base tire 32, calculated based on the state of physical damage to the tire 30 as obtained by inspection using visual inspection of the exterior, an image of the exterior, a shearograph, x-ray, or echo, or the like, to determine whether the tire 30 can be retreaded.

In a case in which the determiner 132 determines in the second determination that retreading of the tire 30 is possible (Yes in step S10), the process proceeds to step S11. In a case in which the determiner 132 determines in the second determination that retreading of the tire 30 is not possible (impossible) (No in step S10), the determiner 132 outputs, as the final determination result, an indication that the tire 30 should be recycled (step S14).

In a case in which the determiner 132 determines that retreading of the tire 30 is possible, the determiner 132 subsequently performs a second-round third determination (additional determination) to determine the cost effectiveness (step S11). In a case in which the determiner 132 determines in the third determination that retreading of the tire 30 is cost effective (Yes in step S12), the process proceeds to step S13. In a case in which the determiner 132 determines in the third determination that retreading is not cost effective (No in step S12), the determiner 132 outputs, as the final determination result, an indication that the tire 30 should be recycled (step S14).

In a case in which it is determined in the second-round third determination that retreading is cost effective, the determiner 132 outputs, as the final determination result, that retreading is possible (step S13). A message indicating the final determination result that retreading is possible may be displayed on a display connected to the server 60, for example, and the user may perform retreading of the tire 30 at the management facility.

As described above, the retreadability determination method and retreadability determination apparatus 10 according to the present embodiment can, with the above-described configuration, accurately determine whether the tire 30 can be retreaded.

Although embodiments of the present disclosure have been described based on the drawings and examples, it is to be noted that various changes or modifications will be apparent to those skilled in the art based on the present disclosure. Therefore, such changes or modifications are to be understood as included within the scope of the present disclosure. For example, the functions and the like included in the components, steps, and the like may be reordered in any logically consistent way, and components, steps, and the like may be combined into one or divided. An embodiment of the present disclosure can also be realized as a program to be executed by a processor provided in an apparatus or as a storage medium with a program recorded thereon. Such embodiments are also to be understood as included within the scope of the present disclosure.

For example, in the above embodiment, the determiner 132 performs the correction for additional use, but the correction for additional use and related processing (steps S6 through S8 in FIG. 4) may be omitted.

For example, in the above embodiment, the determiner 132 performs a correction for additional use, but instead of correction, the first determination may be performed again (the process may return to step S2 in FIG. 4).

For example, in the above embodiment, the first determination is the chemical degradation state determination and the second determination is the physical degradation state determination, but the correspondence may be reversed. In a case in which the first determination is the physical degradation state determination and the second determination is the chemical degradation state determination, a final determination that retreading is not possible can be obtained immediately, without going through the second determination, if there is a large crack or the like in the first determination. In other words, in a case in which the first determination is the physical degradation state determination and the second determination is the chemical degradation state determination, a shortening of the process until obtaining the final determination can be expected.

### REFERENCE SIGNS LIST

10 Retreadability determination apparatus
11 Communication interface
12 Memory
13 Controller
131 Acquisition interface
132 Determiner
20 Vehicle
30 Tire
31 Tread
32 Base tire
40 Network
60 Server

1. A retreadability determination method for determining whether a tire can be retreaded, the tire including a tread and a base tire disposed on a tire radial inner side of the tread, the retreadability determination method comprising:
acquiring a state characteristic value, indicating a state of the tire, to be used in a first determination and a second determination;
executing the first determination; and
executing the second determination in a case in which it is determined in the first determination that the tire can be retreaded, wherein
the first determination is one of a chemical degradation state determination using a residual durability of the base tire calculated based on a chemical change in rubber material of the tire and a physical degradation state determination using a residual durability of the base tire calculated based on a state of physical damage to the tire, and
the second determination is the other of the chemical degradation state determination and the physical degradation state determination.

2. The retreadability determination method according to claim 1, wherein additional use, such that the tire is used for driving while still attached to a vehicle, is possible after the first determination is executed until the second determination is executed.

3. The retreadability determination method according to claim 2, wherein the residual durability of the base tire in the first determination is corrected based on driving conditions of the vehicle in the additional use.

4. The retreadability determination method according to claim 1, wherein the first determination is the chemical degradation state determination.

5. The retreadability determination method according to claim 1, further comprising
executing a third determination in a case in which it is determined in the first determination or the second determination that the tire can be retreaded, wherein
the third determination determines whether the tire can be retreaded by comparing the residual durability of the base tire in the first determination or the second determination with a threshold determined based on a cost of replacement with a new tire.

6. The retreadability determination method according to claim 1, wherein in the physical degradation state determination, the state of physical damage to the tire is obtained by at least one of visual inspection of an exterior of the tire, inspection using an image of the exterior, and inspection of an interior of the tire using a shearograph, x-ray, or echo.

7. The retreadability determination method according to claim 1, wherein in the chemical degradation state determination, the residual durability of the base tire is calculated using a total thermal history including an effect of retreading vulcanization on the tire.

8. A retreadability determination apparatus for determining whether a tire can be retreaded, the tire including a tread and a base tire disposed on a tire radial inner side of the tread, the retreadability determination apparatus comprising:
an acquisition interface configured to acquire a state characteristic value, indicating a state of the tire, to be used in a first determination and a second determination; and
a determiner configured to execute the first determination and execute the second determination in a case in which it is determined in the first determination that the tire can be retreaded, wherein
the first determination is one of a chemical degradation state determination using a residual durability of the base tire calculated based on a chemical change in rubber material of the tire and a physical degradation state determination using a residual durability of the base tire calculated based on a state of physical damage to the tire, and
the second determination is the other of the chemical degradation state determination and the physical degradation state determination.

9. The retreadability determination method according to claim 2, wherein the first determination is the chemical degradation state determination.

10. The retreadability determination method according to claim 2, further comprising
executing a third determination in a case in which it is determined in the first determination or the second determination that the tire can be retreaded, wherein
the third determination determines whether the tire can be retreaded by comparing the residual durability of the base tire in the first determination or the second determination with a threshold determined based on a cost of replacement with a new tire.

11. The retreadability determination method according to claim 2, wherein in the physical degradation state determination, the state of physical damage to the tire is obtained by at least one of visual inspection of an exterior of the tire, inspection using an image of the exterior, and inspection of an interior of the tire using a shearograph, x-ray, or echo.

12. The retreadability determination method according to claim 2, wherein in the chemical degradation state determination, the residual durability of the base tire is calculated using a total thermal history including an effect of retreading vulcanization on the tire.

13. The retreadability determination method according to claim 3, wherein the first determination is the chemical degradation state determination.

14. The retreadability determination method according to claim 3, further comprising
executing a third determination in a case in which it is determined in the first determination or the second determination that the tire can be retreaded, wherein
the third determination determines whether the tire can be retreaded by comparing the residual durability of the base tire in the first determination or the second determination with a threshold determined based on a cost of replacement with a new tire.

15. The retreadability determination method according to claim 3, wherein in the physical degradation state determination, the state of physical damage to the tire is obtained by at least one of visual inspection of an exterior of the tire, inspection using an image of the exterior, and inspection of an interior of the tire using a shearograph, x-ray, or echo.

16. The retreadability determination method according to claim 3, wherein in the chemical degradation state determination, the residual durability of the base tire is calculated using a total thermal history including an effect of retreading vulcanization on the tire.

17. The retreadability determination method according to claim 4, further comprising
executing a third determination in a case in which it is determined in the first determination or the second determination that the tire can be retreaded, wherein
the third determination determines whether the tire can be retreaded by comparing the residual durability of the base tire in the first determination or the second determination with a threshold determined based on a cost of replacement with a new tire.

18. The retreadability determination method according to claim 4, wherein in the physical degradation state determination, the state of physical damage to the tire is obtained by at least one of visual inspection of an exterior of the tire, inspection using an image of the exterior, and inspection of an interior of the tire using a shearograph, x-ray, or echo.

19. The retreadability determination method according to claim 4, wherein in the chemical degradation state determination, the residual durability of the base tire is calculated using a total thermal history including an effect of retreading vulcanization on the tire.

20. The retreadability determination method according to claim 5, wherein in the physical degradation state determination, the state of physical damage to the tire is obtained by at least one of visual inspection of an exterior of the tire, inspection using an image of the exterior, and inspection of an interior of the tire using a shearograph, x-ray, or echo.
